(19) United States
(12) Patent Application Publication
(10) Pub. No.: US 2004/0210834 A1
(43) Pub. Date: Oct. 21, 2004

(54) Data management method and system for generating and verifying accurate coding information

(76) Inventors: Kevin R. Duncan, Bountiful, UT (US); Douglas M. Bean, Centerville, UT (US); Marie Young, Boise, ID (US); Nina Mangelson, Midvale, UT (US); Amy Barton, Bountiful, UT (US); J. P. Yujuico, Monte Sereno, CA (US); Rommel Q. Regalado, Pasig City (PH)

Correspondence Address: Kirton & McConkie, 1800 Eagle Gate Tower, 60 East South Temple, Salt Lake City, UT, 84111, US

(21) Appl. No.: 10/418,844

(22) Filed: Apr. 18, 2003

(51) Int. Cl. G06F 15/00

(52) U.S. Cl. 715/513

(57) ABSTRACT

A data management method and system for generating and iteratively verifying accurate coding information prior to such information being implemented in a document retrieval database. In particular, a statistical sample of coded information is obtained from a document batch and comparatively analyzed to verify an accuracy rate equivalent to or greater than a predetermined quality control standard. If such sample fails to meet the predetermined quality control standard, the entire document batch is returned for recoding. The accuracy of generated coded information is iteratively verified based on a statistical sampling of an increasingly large quantity of generated coded information.

### BACKGROUND OF THE INVENTION

1. Field of the Invention

The present invention relates to an electronic document database management method and system that ensures accurate document information coding to facilitate subsequent document retrieval from a document database. In particular, the present invention relates to a compensation system designed to encourage and reward precise coding practices, and a rigorous verification system designed to ensure a high standard of accuracy and efficiency in document coding.

2. Background and Related Art

Document coding is the process of examining various types of documents and extracting relevant and useful information to make them searchable and retrievable from a computer database. Document coding also enables browsing and linking among documents across a collection.

Many methods and systems for coding documents are presently known. For example, U.S. Pat. No. 6,502,081 to Wiltshire (“Wiltshire”) discloses a scalable machine learning system and process to classify documents according to a hierarchical topic scheme. Although Wiltshire is capable of coding documents on a large scale, Wiltshire's entirely computer-based automated coding technique is incapable of linking otherwise related documents that may not share a common topic or concept scheme.

Other methods, such as that disclosed in U.S. Pat. No. 5,204,812 to Kasiraj (“Kasiraj”), require human intervention to code documents for purposes of classification and access in order to allow more customized coding and linking of unobviously related documents. Kasiraj, however, is practically limited to small scale document coding since the process of linking documents is in no way standardized and highly dependent on individual judgments regarding relatedness. Moreover, Kasiraj is particularly susceptible to mistakes and inconsistencies in coding for the same reasons.

A large organization's documents pose unique difficulties in document coding. For example, in the litigation environment, such documents may be coded according to features typical of prior art automated coding systems such as legal topic, client, adverse party, date, document type, court, and/or relevant key terms, such traditional coding techniques are often inadequate to appropriately associate certain specific evidentiary documents. Indeed, a massive amount of evidentiary information and associated documentation may relate to any one particular case. All such documents are thus likely to contain similar or identical legal topics and key terms and identical client and adverse party information, thus obviating any benefit to such modes of classification. Likewise, date sorting is unlikely to prove fruitful as many documents are likely to be contained within a relatively narrow date range and/or the amount of documents generated on any one date is often too large for efficient searching. Differentiating evidentiary documents according to court and document type is also likely to be of little use when dealing with documents and information related to a single case. The same types of problems exist in coding large scale non-litigation related documents.

Effective large scale coding thus requires complex source coding that is customizable on a project-to-project basis. Such coding practices, however, whether manually or automatically implemented, are inherently prone to mistakes and inconsistencies due to the large volume of documents and information that must be coded and the complexity of necessary coding parameters.

Accordingly, what is needed is a customizable data management method and system capable of generating highly accurate coding information. What is also needed is an efficient data management method and system capable of generating highly accurate coding information within a reasonable period of time. Further what is needed is a data management method and system capable of verifying the accuracy of the coded information generated prior to implementing such information for use in an electronic document database.

### SUMMARY OF THE INVENTION

The present invention is a data management method and system for generating and verifying accurate coding information applicable to large organization databases such as those used in litigation support services. Specifically, the present invention contemplates a system for generating accurate complex source coding involving large numbers of documents. The present invention further contemplates a method and system for verifying the accuracy of coding information comprising iterative verification of accurate coding information through statistical sampling of increasingly large quantities of captured data.

An object of the present invention is to provide a customizable data management method and system that generates highly accurate coding information to enable quality document retrieval.

Another object of the present invention is to provide an efficient data management method and system capable of accommodating and coding a large number of documents within a reasonable period of time.

It is a further object of the present invention to provide a data management method and system that verifies the accuracy of coded information prior to implementing such information in a document database.

These and other features and advantages of the present invention will be set forth or will become more fully apparent in the description that follows. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

The foregoing and other objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 is a diagrammatic flow chart of one embodiment of the data management system of the present invention generally;

FIG. 2 is a flow chart detailing processes that may be implemented in the first processing units of FIG. 1;

FIG. 3 is an exemplary coding user interface for coding documents in accordance with the present invention;

FIG. 4 is a flow chart of one embodiment of the method of the present invention;

FIG. 5 is a flow chart of one embodiment of the method and system of the present invention; and

FIG. 6 is an exemplary diagram of one method for determining compliance with a predetermined quality control standard in accordance with the data management method and system of the present invention.

### DETAILED DESCRIPTION OF THE INVENTION

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

As used in this specification, the term “document” refers broadly to any medium containing information that may be coded for subsequent retrieval according to the data management method and system of the present invention. The term “document batch” refers to any document or combination of documents capable of coding in accordance with the present invention. The term “random sampling” or “statistical sampling” refers to a method of selection of a subset of documents and associated coding information wherein any particular document has an equal chance of selection relative to any other document. Random or statistical sampling may be accomplished by a table of random numbers corresponding to the documents, a computer random number generator, or a mechanical device to select the sample document. The term “ISO 2859 Sampling Standards” refers to quality standards promulgated by the International Organization for Standardization relating to acceptance sampling procedures.

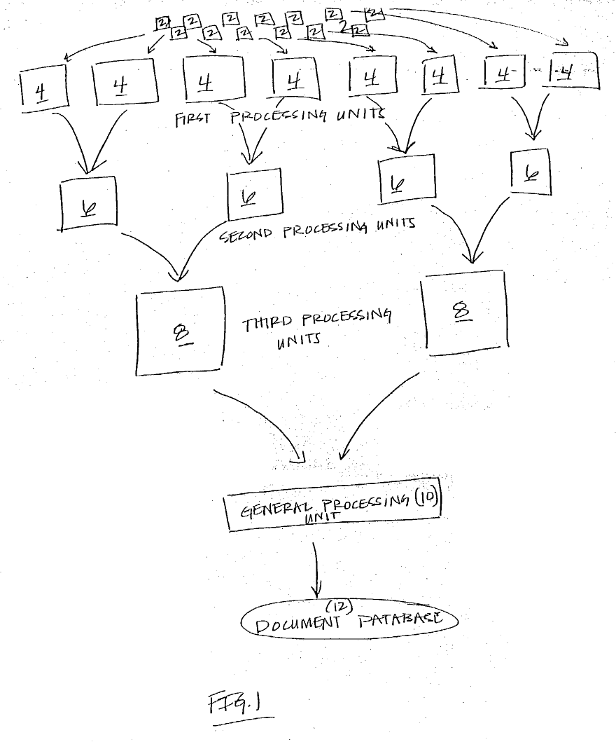

Referring to FIG. 1, the data management system of the present invention may comprise several first processing units 4 capable of processing and coding large volumes of documents. By way of example and not limitation, documents 2 may comprise any quantity of files, papers, books, tape recordings, videocassettes, legal documents, photographs, compact discs, microfiche and/or any other medium for storing information known to those in the art. A first processing unit 4 may comprise a group of specially trained data analysts, computerized means for data analysis, or any other apparatus capable of analyzing and coding a document 2. Once processed and coded, documents 2 may be forwarded to a second processing unit 6 for verifying the accuracy of the coding information obtained. A second processing unit 6 may comprise a group of specially trained data analysts, a specially trained information manager, computerized means for data analysis, or any other apparatus capable of comparatively analyzing documents 2 and coded information to verify the accuracy of the coded information. In one preferred embodiment of the present invention, a plurality of first processing units 4 submit coded documents 2 to a second processing unit 6. A second processing unit 6 may then compile the documents 2 obtained from the first processing units 4 and verify the accuracy of the combined coding information. Such documents 2 and corresponding coding information may then be forwarded to a third processing unit 8 for further verification of accuracy. Again, it is preferred that more than one second processing unit 6 submit coded documents 2 to a third processing unit 8. If the coding information is deemed reliable, the documents 2 and coding information may be finally forwarded to a general processing unit 10. There a final accuracy determination may be made, after which the verified coding information may be input into a general document database 12 for facilitating subsequent document 2 and information retrieval.

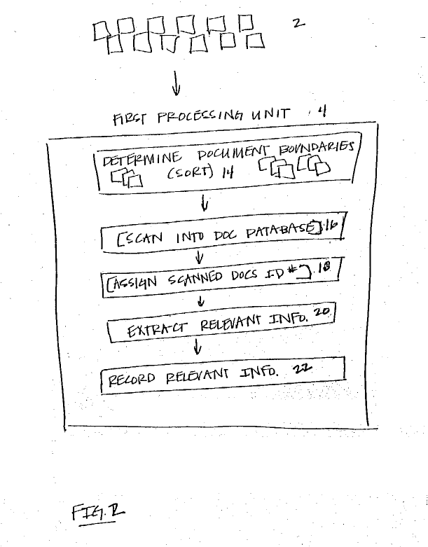

Referring to FIG. 2, document coding in a first processing unit 4 may comprise a series of steps. For example, documents 2 may first be sorted such that related information may be grouped together according to the boundaries of an individual document 14. A document boundary determination assesses whether a document 2 can stand alone. Document boundaries may be determined according to the following five principles. First, documents 2 having discrete authors and recipients are generally treated as separate documents 2. Second, unique document dates may also indicate separate documents 2. Third, successive pagination suggests that the combined pages belong to a single document 2. Fourth, discrete document titles indicate discrete documents 2. Finally, general document type, indicated by document physical format characteristics, may indicate that documents 2 were not created at the same time and thus should be treated discretely.

A next step in document coding may comprise scanning a document 2, or a portion thereof, into a preliminary document coding database 16 by any means known in the art to facilitate future document search and retrieval. Scanned documents 2 subsequently may be assigned an image number based on the order in which they were scanned into the coding database 18. This numerical assignment may also facilitate subsequent search and retrieval of any particular document 2.

A third step in document coding may comprise extracting 20, by visual, electrical, or any other modes of analysis known by those in the art, relevant coding information from a document 2. Such relevant coding information may comprise, for example, topic, client, adverse party, date, document type, court, and/or relevant key terms. Complex coding information such as origin and box information including location, division, office number, employee name, drawer and/or cabinet number, file folder/binder data, map/drawing information and complex details about box contents and relationships between documents may also be extracted. Subjective source coding based on customized parameters such as category, comments, and privileged or confidential status is also contemplated by the present invention, as are any other coding techniques known to those in the art.

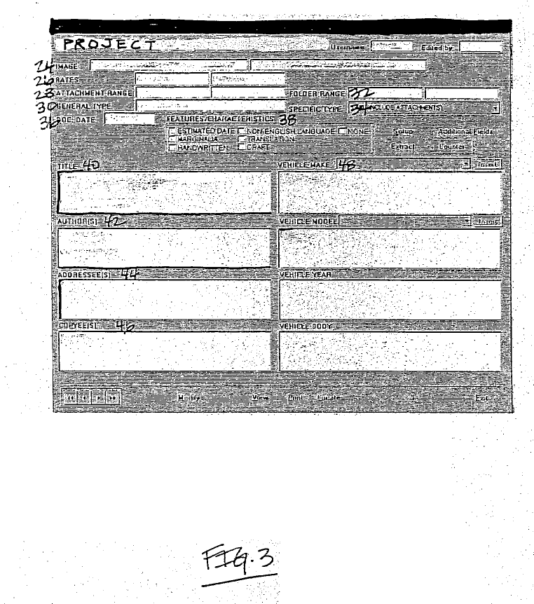

A fourth step in document coding may comprise entering relevant coding information onto a standardized form or user interface 22. Referring now to FIG. 3, such a form or interface may include fields dedicated to capture, for example, an image number assigned to a first page or last page of a document scanned into a preliminary document coding database 24, sequential document control numbers used to identify individual pages of a document 26, control numbers assigned to an entire range of a group of documents 28, numbers assigned to a range of documents in a folder 32, general document type 30, specific document type 34, effective document date 36, names of parties, addresses of parties 44, document title and subject 40, vehicle information 48, document features and characteristics 38, complaint or problem, author 42, court, box number, file number, client number, etc.

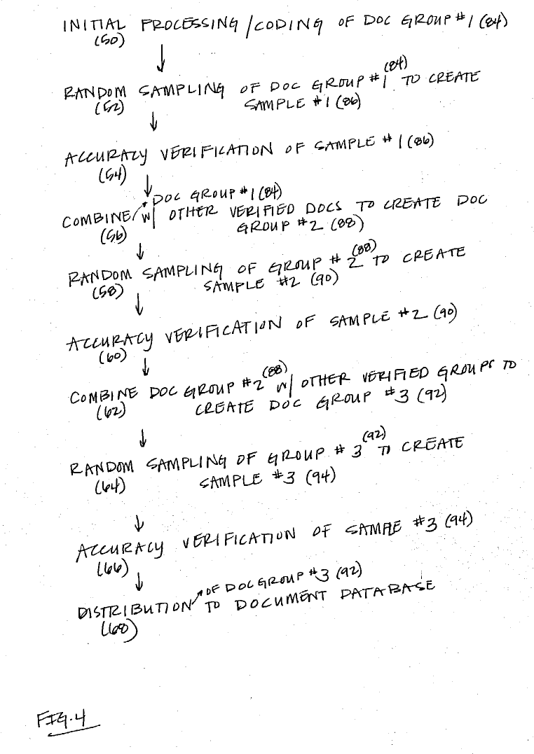

Referring to FIG. 4, the method of the present invention may be initiated by coding and processing 50 a first document group 84. Following such coding and processing 50, a statistical sampling, preferably about 10% of a first document group 84, may be selected from a first document group 84 to create a first sample group 86. A first sample group 86 may then be analyzed to determine whether its corresponding coding information complies with a predetermined quality control threshold 96, for example, within a 3% margin of error. If a predetermined quality control threshold 96 is not met, the first document group 84 may require recoding. Documents 2 requiring recoding may be resubmitted to a first processing center 4 or submitted to any other processing center, person or apparatus known to those in the art to be capable of coding a document 2. If a predetermined quality control threshold 96 is satisfied, a first document group 84 may be combined with other documents 2 whose accuracy has been verified to create a second document group 88 having a greater volume of documents 2 than the first document group 84.

According to certain embodiments of the present invention, analyzing a statistical sample of documents to determine compliance with a predetermined quality control threshold 96 may be achieved according to a two-step process. Such a two-step process first determines the overall accuracy of coded tags or field elements 98 across a given lot of records, then identifies trends and coding errors that are field specific, such as chronically missing tags or field elements 98. Quality coding is thus ensured both superficially and substantively, as a random sampling of specific tags or field elements 98 in the first step generally ensures accurate coding, and tags or field elements 98 that may have evaded quality control by not being included in the first step random tag sampling are isolated and tested in the second step. In this manner, tags or field elements 98 that may have been inadvertently omitted from every coded document, but that avoided error detection in the first step, are identified and accounted for in the second step of the two-step process.

Specifically, a first step comprises random tag inspection based on, for example, ISO 2859 Sampling Standards. Random tag inspection comprises identifying a first lot size corresponding to a quantity of tags or field elements 98 common to a particular document group. In certain embodiments, a computer program may be provided that reads the document group to obtain this information. The lot size may then be inserted into the ISO 2859 sample size equation, namely:

N=(L−(D/2))*(1−(R\hat{ }(1/(D+1)))

where L is the lot size, R is the desired margin of error ratio, and P is the maximum allowed error percentage. N, the result of the equation, indicates the number of tags or field elements 98 to be sampled. If N contains a fraction, its value is rounded up to the nearest integer value. A quantity of tags 98 corresponding to the value for N may then be randomly sampled. In certain embodiments of the present invention, a program that reads the document group and provides a random sample of tags may be used. The sample of tags may then be analyzed to determine compliance with a predetermined quality control threshold 96.

A second step of the two step process comprises isolating a specific tag or field 98 and identifying a second lot size defined by the quantity of documents in a document batch. This second lot size is then entered into the ISO 2859 sample size equation provided above, after which a quantity of documents corresponding to the value of N derived from the sample size equation is randomly sampled. In certain embodiments, a program that reads the document group may be used to randomly select documents for testing. The specific target field of each sampled document may then be analyzed to determine compliance with a predetermined quality control threshold 96, for example, within a 3% margin of error.

According to the iterative method espoused by the present invention, following a determination of compliance with a predetermined quality control threshold as outlined above, documents that meet the threshold may be combined with other documents to create a second document group 88. Randomly selected documents 2 from the second document group 88 may then be compiled to create a second random sample 90, preferably about 10% of a second document group 88. As above, the second sample group 90 may then be analyzed to determine whether its corresponding coding information satisfies a predetermined quality control threshold 96. And likewise, if a predetermined quality control threshold 96 is not met, the second group of documents 88 may require recoding. If, however, a predetermined quality control threshold 96 is met, the second document group 88 may be combined with other verified documents 2 to create a third document group 92 having a greater volume of documents than the second document group 88.

And again, a random sampling, preferably about 10% or a random sample selected according to the two step process delineated above, of a third document group 92 may be taken to create a third sample 94. A third sample 94 may then be analyzed to determine whether the pertinent coded information has been coded with a degree of accuracy greater than or equal to a predetermined quality control threshold 96. If the predetermined quality control threshold is not satisfied, the third document group may require recoding. On the other hand, if the predetermined quality control threshold 96 is met, the coded information corresponding to the third document group 92 may be input into a document database 12 to facilitate subsequent document search and retrieval.

In this manner, large volumes of documents may be processed and analyzed while maintaining a high level of accuracy. Indeed, since accuracy is first verified on a small scale and then at least twice more on an increasingly large scale, quality coding is in no way compromised for increased quantity. Moreover, where human data analysts are involved in the coding process, the possibility that an entire document batch may have to be recoded if a certain quality control threshold 96 is not met provides immense incentive to generate highly accurate codes initially. This incentive may be reinforced by providing compensation-related incentives dependent on consistent achievement of exceptional coding accuracy, achieving a particularly high level of accuracy, or the like.

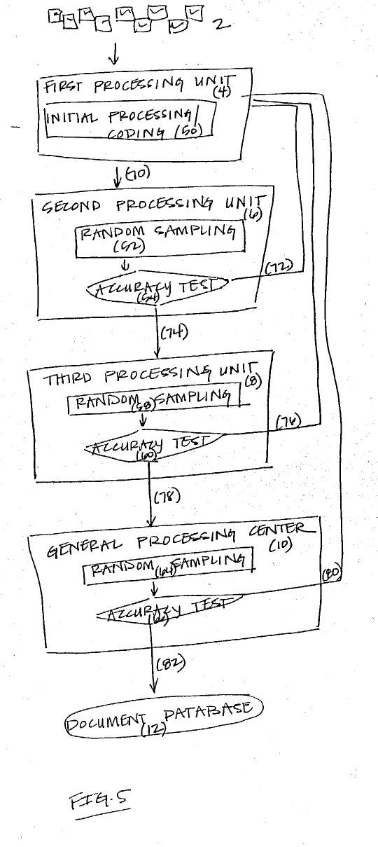

Referring now to FIG. 5, one embodiment of the data management method and system of the present invention may comprise assorted documents 2 which may be submitted to at least one first processing unit 4 for initial processing and coding 50. Upon completion, the now sorted and coded documents 2 may proceed through a first step 70 to a second processing unit 6. A second processing unit 6 may compile the documents 2 and combine such documents with other documents submitted by other first processing units 4. A second processing unit 6 may then collect a random sample of such documents 52 and analyze the coding information corresponding to such documents for accuracy 54. If the accuracy of the coding information does not meet a certain quality control threshold 96, the documents 2 follow path 72 for return to a first processing unit 4 for recoding. If, however, the coding information is more accurate than a quality control threshold 96, the documents 2 follow path 74 to a third processing unit 8. A third processing unit 8 may complete the same series of processing steps as the second processing unit 6, namely documents 2 are combined with other documents received from other second processing units 6, a random sample taken 58, and the accuracy of the random sample 58 determined according to a predetermined quality control threshold 96. If the threshold 96 is not met, the documents 2 follow path 76 to a first processing unit 4 for recoding. If instead the threshold 96 is adequately satisfied, the documents 2 follow an alternative path 78 to a general processing center 10.

A general processing center 10 iterates the processing steps of the second 6 and third 8 processing units, such that documents 2 are combined, a random sample obtained 64, and an accuracy test conducted 66 based on a predetermined quality control threshold 96. If the threshold 96 is met, the coded information corresponding to the documents is entered into a document database 12 for future document use and retrieval. If, on the other hand, the threshold 96 is not met, the entire group of documents 2 is redisbursed to first processing units 4 for recoding. In this manner, accurate coding information is statistically guaranteed above a certain predetermined quality control threshold 96.

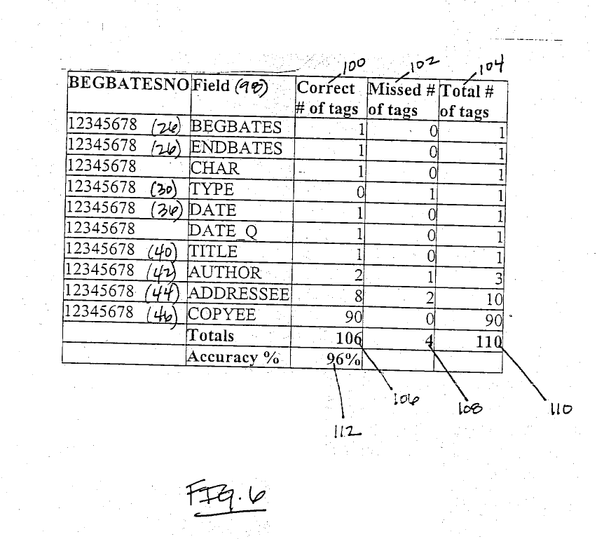

Referring now to FIG. 6, accuracy of coding information may be determined by comparatively analyzing accurately coded information to inaccurately coded information. Specifically, a tag 98, or item requiring coding, may be identified in a document 2. The corresponding coded information form or user interface, as depicted by FIG. 3, may then be examined to veify that a corresponding tag 98 is properly reflected by the coded information. If reference to the tag 98 in the coded information is missing, incomplete or inaccurate, existence of the tag 98 may be noted as a mark in the total number of tags column 104 as well as referenced in the inaccurate tag column 102. A missing, incomplete or inaccurate tag 98 may not be included in the tally for accurate tags 100. If, on the other hand, a tag 98 identified in a document 2 is properly reflected in the corresponding coded information, the tag 98 may be tallied in the total number of tags column 104 as well as in the accurate tags column 100. After all tags 98 have been identified in a document 2 and accounted for in the coded information, final tag tallies may be entered into the accurate tag column 100, inaccurate tag column 102, and total tag column 104, respectively.

According to one embodiment of the present invention, tags 98 may be broken down according to tag type to facilitate accurate tag tallies. For example, FIG. 6 illustrates a spreadsheet for determining an extent of accurate coding information wherein tags 98 are broken down into discrete field categories 106. Field categories 106 may include any or all tag types used to code information from an existing document 2, for example, an image number assigned to a first page or last page of a document scanned into a preliminary document coding database 24, sequential document control numbers used to identify individual pages of a document 26, control numbers assigned to an entire range of a group of documents 28, numbers assigned to a range of documents in a folder 32, general document type 30, specific document type 34, effective document date 36, names of parties, addresses of parties 44, document title and subject 40, vehicle information 48, document features and characteristics 38, complaint or problem, author 42, court, box number, file number, client number, etc. Alternatively, field categories 106 may broadly encompass more than one tag type, for example, general document type 30 tags and specific document type 34 tags may be tallied together under a field category 106 entitled, for example, “document type.”

After all field category tallies 106 have been completed according to correct number of tags, incorrect number of tags, and total tags, each column 100, 102 and 104 may be individually totaled. The total number 106 recorded in the correct number of tags column 100 may then be divided by the total number 110 recorded in the total number of tags column 104. A resulting ratio or percentage indicates a degree of accuracy 112 reflected by the coding information generally. This degree of accuracy 112 may then be compared to a predetermined quality control threshold 96, preferably about 95%, below which an appropriate document batch may be returned for recoding.

What is claimed is:

1. A data management method for generating and verifying accurate coding information, said method comprising:
obtaining a plurality of document batches, each document batch comprising a plurality of documents;
coding information corresponding to each document;
producing a first coded document batch comprising said plurality of documents and said corresponding coded information;
obtaining a first random sample of documents from said first coded document batch;
verifying the accuracy of said first random sample; and
recoding said first coded document batch if said accuracy is less than a predetermined quality control standard.

2. The method of claim 1, wherein said obtaining a first random sample of documents further comprises:
identifying a first lot size corresponding to a quantity of tags present in each of said plurality of documents;
entering said first lot size into a sample size equation to determine a first appropriate sample size; and
randomly sampling said first appropriate sample size from said first coded document batch.

3. The method of claim 2, further comprising:
specifying a target field from said coding information;
identifying a second lot size corresponding to a quantity of said plurality of documents;
entering said second lot size into said sample size equation to determine a second appropriate sample size; and
randomly sampling said second appropriate sample size from said first coded document batch.

4. The method of claim 1, further comprising:
providing a second coded document batch, said second coded document batch comprising a plurality of verified first coded document batches;
obtaining a second random sample of documents from said second coded document batch;
verifying the accuracy of said second random sample; and
recoding said second coded document batch if said accuracy is less than said predetermined quality control standard.

5. The method of claim 4, wherein said obtaining a second random sample of documents further comprises:
identifying a first lot size corresponding to a quantity of tags present in each of said plurality of documents present in said second coded document batch;
entering said first lot size into a sample size equation to determine a first appropriate sample size; and
randomly sampling said first appropriate sample size from said second coded document batch.

6. The method of claim 4, further comprising:
specifying a target field from said coding information;
identifying a second lot size corresponding to a quantity of documents present in said second coded document batch;
entering said second lot size into said sample size equation to determine a second appropriate sample size; and
randomly sampling said second appropriate sample size from said second coded document batch.

7. The method of claim 4, further comprising:
providing a third coded document batch, said third coded document batch comprising a plurality of verified second coded document batches;
obtaining a third random sample of documents from said third coded document batch;
verifying the accuracy of said third random sample; and
recoding said third coded document batch if said accuracy is less than said predetermined quality control standard.

8. The method of claim 7, further comprising transferring said third coded document batch to a document database if said accuracy is greater than or equal to said predetermined quality control standard.

9. The method of claim 1, further comprising distributing said plurality of document batches to a first processing center.

10. The method of claim 9, wherein said coding is performed by said first processing center.

11. The method of claim 10, wherein said first processing center comprises at least one data analyst.

12. The method of claim 1, wherein said predetermined quality control standard comprises at least 95% accuracy.

13. The method of claim 1, wherein said predetermined quality control standard comprises at least 97% accuracy.

14. A data management system for generating and verifying accurate coding information, said system comprising:
at least one first processing center for coding information corresponding to a plurality of documents;
at least one second processing center for verifying the accuracy of a random sample of said documents and said corresponding coded information according to a predetermined quality control threshold.

15. The system of claim 14, wherein said at least one second processing center returns said documents to said at least one first processing center for recoding if said predetermined quality control threshold is not met.

16. The system of claim 14, wherein said at least one second processing center forwards a first document batch comprising said documents and said corresponding coded information to a third processing center for reverification if said predetermined quality control threshold is met.

17. The system of claim 14, further comprising at least one third processing center, wherein said at least one third processing center verifies the accuracy of a random sample of said first document batch according to said predetermined quality control threshold.

18. The system of claim 17, wherein said at least one third processing center returns said first document batch to said at least one first processing center for recoding if said predetermined quality control threshold is not met.

19. The system of claim 17, wherein said at least one third processing center forwards a second document batch comprising at least one first document batch to a general processing center for reverification and transmission to a document database if said predetermined quality control threshold is met.

20. The system of claim 17, further comprising at least one general processing center, wherein said at least one general processing center verifies the accuracy of a random sample of said second document batch according to said predetermined quality control threshold.

21. The system of claim 20, wherein said at least one general processing center returns said second document batch to said at least one first processing center for recoding if said predetermined quality control threshold is not met.

22. The system of claim 20, wherein said at least one general processing center transfers said second document batch to a document database if said predetermined quality control threshold is met.

23. The system of claim 14, wherein said quality control threshold comprises at least 95% accuracy.

24. The system of claim 14, wherein said quality control threshold comprises at least 97% accuracy.

25. The system of claim 14, wherein said first processing center comprises at least one data analyst.
